(19) United States
(12) Patent Application Publication
(10) Pub. No.: US 2011/0005157 A1
(43) Pub. Date: Jan. 13, 2011

(54) Masonry Block and Associated Methods

(76) Inventor: Daniel J. Pratt, Kaysville, UT (US)

Correspondence Address: THORPE NORTH & WESTERN, LLP., P.O. Box 1219, SANDY, UT, 84091-1219, US

(21) Appl. No.: 12/886,037

(22) Filed: Sep. 20, 2010

Related U.S. Application Data
(63) Continuation of application No. 11/986,683, filed on Nov. 21, 2007.
(60) Provisional application No. 60/860,925, filed on Nov. 22, 2006.

(51) Int. Cl. E04C 1/00; B44F 9/04; B29C 39/44

(52) U.S. Cl. 52/311.1; 52/606; 264/40.1

(57) ABSTRACT

A cementitious masonry block that exhibits the appearance of finished natural stone comprises at least two substantially parallel stacking sides operable to be installed on or over other blocks to form a block wall. At least one hollow cell is formed in the block to provide a void for structural reinforcing. One or more display faces each exhibits a finish applied by natural stone finishing techniques. The block is formed from a cementitious mixture that is substantially homogenous throughout the masonry block and that, when cured, is substantially matched in color or grain, or both, to the natural stone that is being replicated.

This application is a continuation of U.S. patent application Ser. No. 11/986,683, filed Nov. 21, 2007, which claimed priority of U.S. Provisional Patent Application No. 60/860,925, filed Nov. 22, 2006, both of which are hereby incorporated herein in their entirety.

### BACKGROUND

1. Field of the Invention

The present invention relates generally to masonry blocks (also known as Concrete Masonry Units, CMUs, or Cinder Blocks) and systems for making and/or finishing and/or installing such masonry blocks. More particularly, the present invention relates to masonry blocks, and associated methods, that provide the aesthetic of finished natural stone.

2. Related Art

The appearance of structures formed of natural stone is appreciated by many people. As such, it is no surprise that efforts have been made to form buildings, retaining walls, and the like from natural stone. However, for a variety of reasons, using natural stone in modern building projects is not always a viable option. For example, the cost of obtaining and forming natural stone into units suitable for conventional building projects is often extraordinarily high. In addition, natural stone is not generally recognized as being structurally sound, and so the use of natural stone as a load-bearing component of structures is often not authorized by building codes.

For at least these reasons, many builders have attempted to utilize facing materials (or veneer materials) that provide the appearance of natural stone to a conventional wall. Such materials can be installed on the face of a load bearing wall in a variety of manners, as is well known in the art. While natural stone veneer materials, or other veneer materials that provide the look of natural stone are commonly available, they suffer from a number of drawbacks. For example, such materials are relatively costly to use because a load bearing wall must be erected first, after which the veneer materials can be applied to the face of the load bearing wall. This process not only increases the cost associated with creating two distinct structures (the load bearing wall and the veneer portion), it greatly extends the project time required to complete the wall.

Due to these considerations, attempts have been made to create materials that can both provide the appearance of natural stone, and that can be used in load bearing walls to alleviate the need to apply a decorative face to a load bearing wall after it has been constructed. Many of these attempts involve splitting a concrete-based workpiece into two or more block pieces in a manner that provides the faces resulting from the split with an uneven, more natural look. Additional processes, such as “tumbling,” can be utilized to further reduce the face (or corners of the face) of the block pieces to provide a more natural appearing face. Other processes attempt to grind, chip, hammer, or otherwise remove portions of the edges or faces of block pieces to enhance the appearance of the block.

Blocks of this type have been used to create load bearing walls with a more natural appearance than conventional block walls. However, it has been found that these types of conventional processes are either overly expensive or do not provide a sufficiently realistic appearance of finished (e.g., hand-pitched, hand-faced, sandblasted, etc.) natural stone. Thus, despite attempts to date, a need remains for systems that allow cost-effective production of load-bearing concrete masonry units that provide a realistic appearance of finished, natural stone.

### SUMMARY OF THE INVENTION

It has been recognized that it would be advantageous to develop a masonry block forming system that can be used to form masonry blocks (or units) suitable for use in constructing load bearing walls that exhibit a realistic, finished natural stone appearance.

The invention provides a cementitious masonry block that exhibits the appearance of finished natural stone, including at least two substantially parallel stacking sides operable to be installed on or over other blocks to form a block wall. At least one hollow cell can be formed in the block to provide a void for structural reinforcing. One or more display faces can each exhibit a finish applied by natural stone finishing techniques. The block can be formed from a cementitious mixture that is substantially homogenous throughout the masonry block and that, when cured, is substantially matched in color or grain, or both, to the natural stone that is being replicated.

In accordance with another aspect of the invention, a method of replicating an appearance of a specific, finished natural stone with a plurality of cementitious masonry blocks is provided, including: creating a concrete mix design that, when cured, is matched in color or grain, or both, to the natural stone being replicated; forming the concrete mix into an uncured masonry block having at least one hollow cell formed therein to provide a void for structural reinforcing; and curing the uncured masonry block to create the cementitious masonry block.

In accordance with another aspect of the invention, a method of forming a cementitious masonry block that exhibits the appearance of natural stone is provided, including: obtaining a concrete mix design that, when cured, is matched in color or grain, or both, to the natural stone being replicated; forming the concrete mix design into an uncured block, the uncured block having: a length at least 24 inches; at least one hollow cell formed in the block to provide a void for structural reinforcing; and one or more display faces operable to have a finish applied thereto by natural stone finishing techniques; and curing the uncured block to create the cementitious masonry block.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying exemplary claims, or may be learned by the practice of the invention.

### BRIEF DESCRIPTION OF THE DRAWINGS

FIG. 1 is a perspective view of an exemplary cementitious or concrete-based workpiece prior to the workpiece being split by a schematically illustrated splitting device;

FIG. 2 is a perspective view of an unfinished concrete masonry unit or block in accordance with the present invention, shown as half of the concrete-based workpiece of FIG. 1 (after the workpiece has been split into two);

FIG. 3 is a perspective view of the concrete masonry unit or block of FIG. 2, after being processed to include a display face that exhibits a finish applied by natural stone finishing techniques;

FIG. 4 is a top, partially sectioned view of a portion of a series of intersecting walls formed from cementitious blocks of the present invention;

FIG. 5 is a photograph of a corner of a building formed from cementitious blocks of the present invention;

FIG. 6 is a photograph of a cementitious block formed in accordance with the present invention; and

FIG. 7 is a photograph of an elongate cementitious block formed in accordance with the present invention.

It will be understood that the attached figures are merely for illustrative purposes in furthering an understanding of the invention. The figures may not be drawn or shown to scale, thus dimensions, particle sizes, and other aspects can be exaggerated to make illustrations thereof clearer. Therefore, departure can be made from the specific dimensions and aspects shown in the figures in order to produce the cementitious blocks of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an” and “the” include plural referents unless the context clearly dictates otherwise. Thus, for example, reference to “a cementitious block” can include one or more of such blocks.

### DEFINITIONS

In describing and claiming the present invention, the following terminology will be used in accordance with the definitions set forth below.

As used herein, relative terms, such as “upper,” “lower,” “upwardly,” “downwardly,” etc., are used to refer to various components of masonry blocks or units of the present invention, as those terms would be readily understood by one of ordinary skill in the relevant art. It is to be understood that such terms in no way limit the present invention but are used to aid in describing the components of the masonry block system, and building structures composed of such blocks generally, in the most straightforward manner.

As used herein, the term “natural stone finishing technique(s)” is to be understood to refer to techniques conventionally utilized to finish natural stone. Such techniques include, without limitation, techniques resulting in so-called cut-face finishes, thermal finishes, dressed face finishes, hand-pitched finishes, hand-faced finishes, sandblasted finishes, and the like, as would be understood by one having ordinary skill in the art of stone-cutting or stone finishing. As used herein, the term “natural stone finishing technique(s)” can, but does not necessarily, exclude techniques commonly used to work masonry blocks.

As used herein, the term “substantially” refers to the complete or nearly complete extent or degree of an action, characteristic, property, state, structure, item, or result. As an arbitrary example, when an object or group of objects is/are referred to as being “substantially” symmetrical, it is to be understood that the object or objects are either completely symmetrical or are nearly completely symmetrical. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As an arbitrary example, an opening that is “substantially free of” material would either completely lack material, or so nearly completely lack material that the effect would be the same as if it completely lacked material. In other words, an opening that is “substantially free of” material may still actually contain some such material as long as there is no measurable effect as a result thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, particle sizes, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

### The Invention

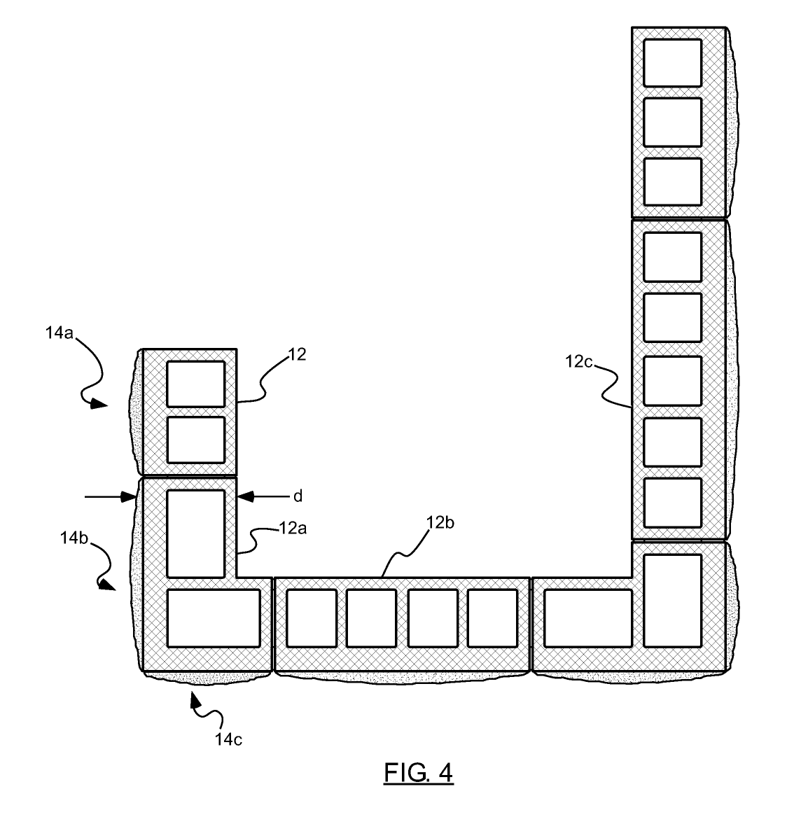

As shown generally in FIG. 3, the present invention provides a cementitious or concrete masonry block or unit 12 that is formed so as to be suitable for use in constructing a load-bearing wall, and that also exhibits the appearance of finished natural stone on at least one display face of the block. In the example shown in FIG. 3, the block includes a display face 14a that exhibits the appearance of hand-faced or hand-pitched natural stone, such as, for example, sandstone, granite, limestone, etc. While a single display face 14a is shown in FIG. 3, it is to be understood that more than one face of the block 12 can be formed to exhibit the appearance of hand-pitched natural stone. For example, as shown in FIG. 4, masonry block 12 includes a single display face 14a while masonry block 12a includes two display faces, 14b and 14c, which are formed at right angles (e.g., orthogonally) to one another so as to serve as a corner block.

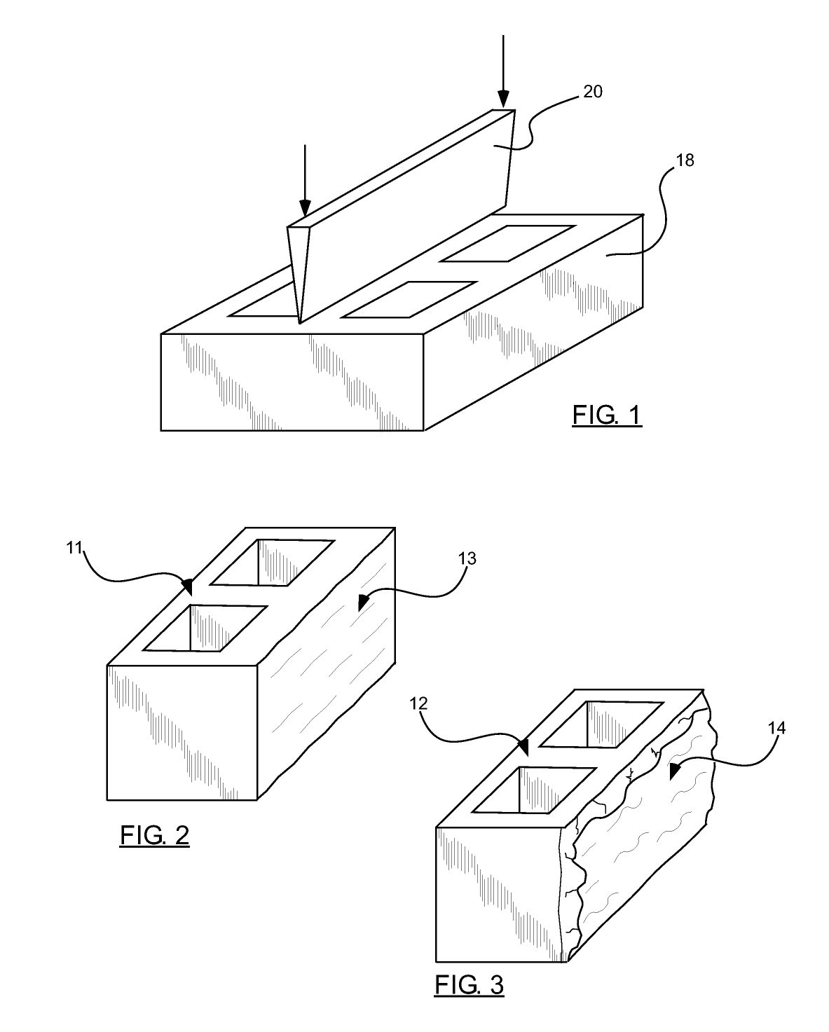

The masonry block 12 can be formed from a variety of materials, but is generally formed from a cementitious mixture. In one embodiment of the invention, shown in FIGS. 1-3, the block can begin as a portion of a concrete-based workpiece 18 that is split, by way of a variety of methods, into two segments. Generally, one or more splitting devices (shown schematically and arbitrarily at 20) can be used to apply a localized force to a plane of the concrete-based workpiece to cause the workpiece to split into two masonry blocks or units. One such block is shown at 11 in FIG. 2, with generally planar walls, save for split face 13 that can be slightly more rough than the remaining faces due to the splitting process.

While only one generic splitting device 20 is shown in the figures, it is to be understood that more than one splitting device can be utilized, and that splitting devices applying force to multiple sides of the concrete-based workpiece can be utilized, as would occur to one having ordinary skill in the art having possession of the present disclosure. In particular, it may be the case that applying splitting device forces to two opposing faces of the block would more accurately and effectively split the block.

After the block 11 has been created, a variety of methods can be utilized to apply a finish to the split face 13 to create the natural stone appearance exhibited by the display face 14a shown in FIG. 3. The display face can be created by way of manual pitching (e.g., utilizing a hammer and chisel, as in the art of stone masonry, to remove pieces around the perimeter of the masonry block). Automatic methods can also be used, including, without limitation, tools commercially available on the market used for manually splitting block, or large production machines yet to be developed that may allow all or part of the pitching to be done as a streamlined component of the production line. The present invention can provide a particular design for the modification of, or altering of, a variety of generic blades to assist in the splitting operation.

In addition to exhibiting the hand-pitched or hand-faced appearance of finished natural stone, the present invention can be utilized to provide to the block a variety of appearances. Due to the nature of the present blocks, they can generally be finished utilizing most of the known techniques that are used to finish natural stone, including but not limited to, cut-face finishes, thermal finishes, dressed-faced finishes, tooled-face finishes, sandblasted, etc. Each of these finishes can be applied to individual blocks, and combinations of the finishes can also be used (e.g., the finish applied to the corners or edges of the blocks can differ from the finish applied to the center area of the block). Some of these finishes can begin with a workpiece having an “as-cast” finish (also known as a standard or a smooth finish), which may negate the need to split the workpiece.

The materials used in the cement design mix can vary widely, and can include sand, cement, various additives (e.g., admixtures), integral water-proofing, colorant, color-matched aggregates, etc. Each of these ingredients can be tailored or selected to produce a finished product that resembles the appearance of a piece of finished natural stone. The selection and proportions of materials in the mix design can vary based on the raw materials locally available and on the nature of the natural stone to be replicated. For example, a red sandstone block may utilize a uniform color of sand as the sole aggregate, whereas a granite stone may intentionally use multi-colored, pebble-sized aggregate to replicate natural granite.

In one aspect of the invention, the split face 13, after the initial splitting of the block, can be significantly thicker on the front (e.g., display) face than on the back or side faces. In this aspect of the invention, the block molds can be configured to “unbalance” the faces of the block so that the display face 14a can be given a much deeper or profound cleft through the pitching process. In this manner, the finished blocks can still have enough remaining wall thickness such that the edges of the display face after finishing can be approximately the same thickness as the edges of the un-finished faces (approximately the same width as the edges of standard blocks prior to finishing). This can result in an overall block thickness greater than standard masonry block. For example, while a standard 8 inch masonry block may produce an overall block thickness of 8 inches, the overall block thickness of an “8 inch” wall formed of the present blocks can be closer to 10 inches.

To further enhance the appearance of the block 12, the composition of the cementitious mixture used in the block can be altered. For example, in one aspect of the invention, the composition of the cementitious mixture can differ from a composition of a conventional masonry block in one or more characteristics. Characteristics that can differ include, without limitation, color of aggregates (including colorant added to the concrete mix as well as the color and texture of “filler” materials), size of aggregate materials, texture of aggregate materials, bonding properties of aggregate materials, density of aggregate materials, etc.

In one aspect of the invention, the composition of the cementitious mixture used for the block is tailored such that, when the block is cured, the block exhibits the appearance of natural stone whether the block has been honed, sandblasted, pitched, tooled, polished, etc. In this manner, the stone can be used in a variety of applications and contractors can “mix and match” honed pieces for use around openings, pitched pieces for flat wall applications, dressed pieces for decorative areas, etc. The present system can thus allow one type of concrete masonry unit to be tailored to a variety of applications in a single job, and from one job to another job.

One manner in which the composition of the cementitious mixture can be altered is by reducing or eliminating large pieces of aggregate in the mixture. As such large pieces of aggregate do not generally appear in natural stone, their presence in the concrete masonry block 12 can detract from the natural stone appearance. In one aspect of the invention, the concrete mix is designed such that no component of the mix is larger than about ¼ inch. In another aspect, the mix is designed such that no component of the mix is larger than about ⅛ inch. In another aspect, no component is larger than about 1/16 inch. In yet another example, no component can be larger than about 1/64 inch.

Also, in one embodiment, any or most of the aggregate added to the cementitious mixture can be selected so as to match a color of the mixture as a whole. In this manner, the presence of any relatively large aggregate pieces can be at least partially masked or hidden. While aggregate is sometimes used as “filler” in conventional concrete masonry blocks, the present inventor has found that the use of aggregate (or aggregate with large components) can be reduced or eliminated to positively affect the appearance of the blocks 12 while perhaps only slightly increasing an overall weight of the block by requiring additional cement, sand, or other fillers in the mixture.

The color of the cementitious mixture, including any aggregate material, can be tailored to match a specific stone, as may be desirable by the architect or builder. One manner in which this can be accomplished is to utilize pieces or chips of locally available stone as the aggregate (or filler) material, and tailor a color of the remaining portion of the mixture to match the color and/or appearance, texture, etc., of the locally available stone aggregate. In this manner, a load-bearing wall having the appearance of locally-available stone can be erected for much less expense, and having much better structural properties, than if the locally-available stone were used.

While a higher concentration of cement in the mixture may increase the weight and cost of the concrete masonry block 12, the present inventor has found that the present system can provide significant cost savings over conventional veneer systems. For example, the present inventor estimates that a highly aesthetically pleasing, load-bearing wall can be erected using the present system for around $20-30/ft². In contrast, conventional CMU walls (which do not provide the appearance of natural stone) can be erected for around $15-20/ft². A natural stone veneer system can cost upwards of $60-80/ft², including the costs of the structural load bearing wall. Thus, the present system can significantly lower costs over natural stone veneer systems, can be installed in much less time than veneer systems, and can provide a natural stone appearance that is comparable or better than conventional veneer systems.

The present invention can provide sufficient flexibility to allow local manufacturers (and/or installers) to utilize a variety of mix designs and specific types and quantities of materials. The present invention can provide general instructions to the block manufacturer, and offer assistance in manners in which the general format can be altered by the local manufacturer to maintain the integrity of the present invention while utilizing the local manufacturer's existing mix designs and processes, and locally available aggregates.

In addition to the structural components discussed above, the present invention also provides a method of replicating an appearance of a specific, finished natural stone with a plurality of cementitious masonry blocks, including: creating a concrete mix design that, when cured, is matched in color, grain, texture, etc., to the natural stone being replicated; forming the concrete mix into an uncured masonry block having at least one hollow cell formed therein to provide a void for structural reinforcing; and curing the uncured masonry block to create the cementitious masonry block.

The method can further include comparing an appearance of the resultant cementitious masonry block to the appearance of the finished natural stone; and based on the comparison, modifying the concrete mix design to more closely match the appearance of the cementitious masonry blocks with the appearance of the finished natural stone.

The method can also include applying a finish to the cementitious masonry blocks with natural stone finishing techniques.

In addition, a method of forming a cementitious masonry block that exhibits the appearance of natural stone is provided, including: obtaining a concrete mix design that, when cured, is matched in color or grain, or both, to the natural stone being replicated; forming the concrete mix design into an uncured block, the uncured block having: a length at least 24 inches; at least one hollow cell formed in the block to provide a void for structural reinforcing; and one or more display faces operable to have a finish applied thereto by natural stone finishing techniques; and curing the uncured block to create the cementitious masonry block.

The invention may also include smaller sized block, similar in size to those found with conventional masonry blocks, as needed to offer a full range of sizes for a contractor to choose from.

The present invention can provide blocks having a variety of sizes and shapes. In particular, the blocks produced can, if desired, include curved display faces and can be sized smaller or larger than the blocks illustrated. In one aspect of the invention, the molds used to form the masonry blocks can be varied or adjustable to allow for the intentional production of slightly smaller or larger blocks to simulate the variance in size found in natural stone components.

The present invention can also produce blocks having lengths greater than conventional CMUs, on the order of about 24 inches, about 32 inches, or about 40 inches. The length of the present blocks can be selected to appear more similar to the natural stone being replicated. Also, by varying the length of adjacent blocks in a block wall, the appearance of natural stone can be further improved, as the wall will not have such a standardized look that is typical of CMU block walls.

FIG. 4 illustrates (in top view) an exemplary application in which blocks of the present invention have been utilized to form three intersecting walls. The walls can include blocks 12, 12a, 12b, 12c, etc. This embodiment of the invention illustrates the variety made possible by the present invention, with varying lengths of blocks being installed near one another in the wall. This configuration can better replicate the appearance of walls formed from natural stone, as such walls are often more random and include more variation than do conventional CMU walls (which are often very uniform patterns of repeating 8×8×16 inch blocks).

In addition, FIG. 4 illustrates a further aspect of the invention in which block 12a includes two display faces, 14b, 14c, arranged orthogonally (e.g., perpendicularly) to one another. In this aspect of the invention, each of the display faces include a length of at least about 16 inches. In this manner, the corner structure, when viewed from either side, does not closely resemble the corner structure of a typical CMU wall, as the corner extends beyond the standard thickness for such walls. In other words, display face 14c (being the shorter of the two faces) would, in a conventional CMU wall, be no longer than a depth “d” of the block 12a, and might be shorter than this depth. As such, a very uniform, conspicuous look is provided to the wall.

By forming the display face 14c of the present block 12a with a length longer than a depth “d” of the block 12a, the corner structure appears more closely like that of a traditional stone wall, not a CMU wall.

In addition to the specific dimensions provided herein, it is to be understood that the present blocks can be formed in a variety of heights, lengths, etc. By varying the dimensions of the blocks from traditional 8×8×16 inch dimensions found with typical CMU products, the replication of conventional stone walls can be enhanced. The present blocks can be formed in heights of about 8 inches, 10 inches, 12 inches, etc. Similarly, the depth “d” of the blocks can vary from about 8 inches, 10 inches, 12 inches, etc.

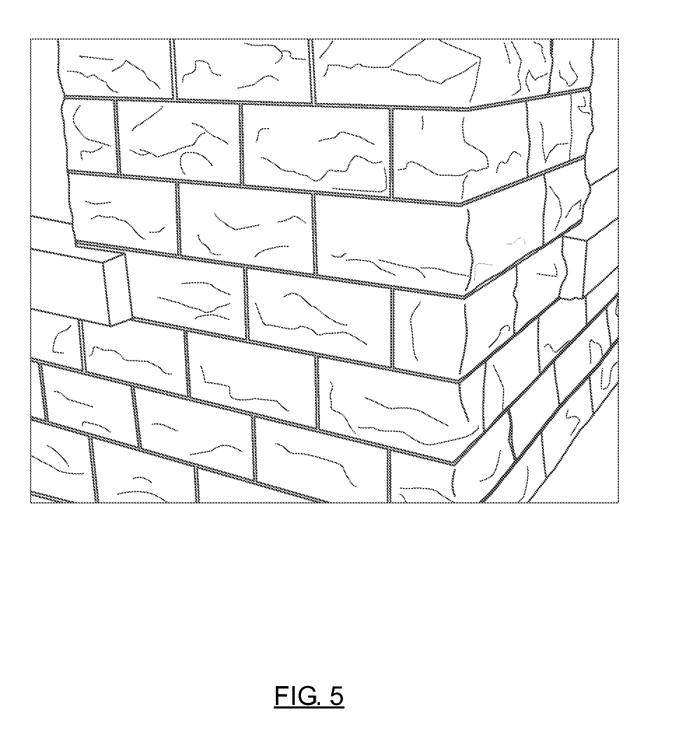

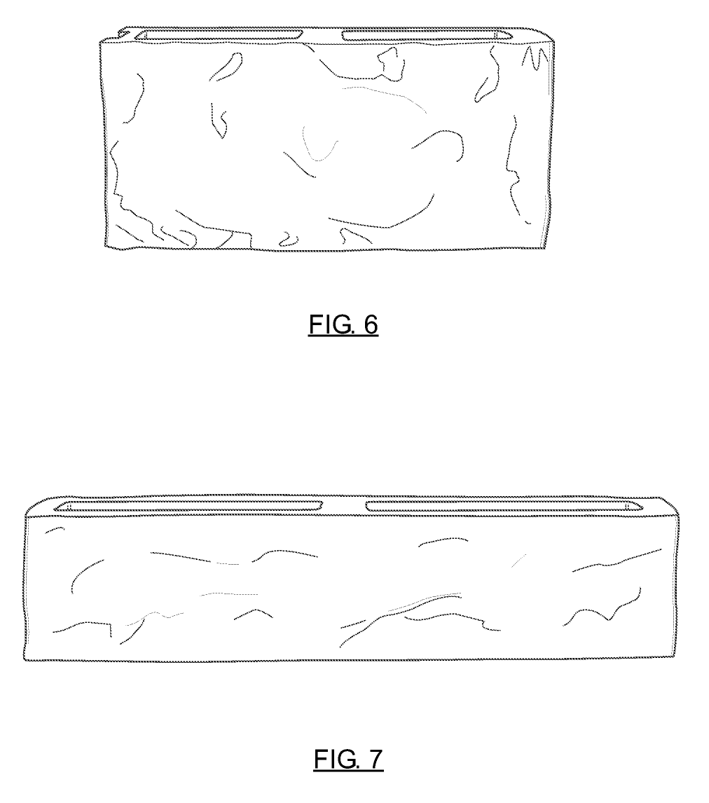

FIGS. 5, 6 and 7 are photographs of exemplary applications of the present invention, provided to more clearly indicate one exemplary finish that can be applied to the present blocks. In the examples shown, a sandstone natural stone is replicated. It will be appreciated that the present blocks can be formed so as to be nearly indistinguishable from natural sandstone, as well as a wide variety of other stone types.

It is to be understood that the above-described arrangements are only illustrative of the application of the principles of the present invention. Numerous modifications and alternative arrangements may be devised by those skilled in the art without departing from the spirit and scope of the present invention and any appended or following claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A cementitious masonry block that exhibits the appearance of finished natural stone, comprising:
at least two substantially parallel stacking sides operable to be installed on or over other blocks to form a block wall;
at least one hollow cell formed in the block to provide a void for structural reinforcing;
one or more display faces, each exhibiting a finish applied by natural stone finishing techniques; and
the block being formed from a cementitious mixture that is substantially homogenous throughout the masonry block and that, when cured, is substantially matched in color or grain, or both, to the natural stone that is being replicated.

2. The masonry block of claim 1, wherein the one or more display faces include a thickness at least twice as great as a thickness of non-display face sides of the block.

3. The masonry block of claim 2, wherein the one or more display faces include a thickness of about 3.5 inches.

4. The masonry block of claim 1, wherein the cementitious mixture includes no particles greater than about ⅛ inch in diameter.

5. The masonry block of claim 4, wherein the cementitious mixture includes no particles greater than about 1/64 inch in diameter.

6. The masonry block of claim 1, wherein a length of at least one display face of the block is at least about 24 inches.

7. The masonry block of claim 1, wherein the finish applied by natural stone finishing techniques includes at least one of: a hand-pitched finish; a cut face finish; a thermal finish; a dressed faced finish; a tooled face finish; and a sandblasted finish.

8. The masonry block of claim 1, further comprising a plurality of hollow cells formed in the block, the cells being spaced substantially equally from one another.

9. A method of replicating an appearance of a specific, finished natural stone with a plurality of cementitious masonry blocks, comprising:
creating a concrete mix design that, when cured, is matched in color or grain, or both, to the natural stone being replicated;
forming the concrete mix into an uncured masonry block having at least one hollow cell formed therein to provide a void for structural reinforcing; and
curing the uncured masonry block to create the cementitious masonry block.

10. The method of claim 9, further comprising:
comparing an appearance of the resultant cementitious masonry block to the appearance of the finished natural stone; and
based on the comparison, modifying the concrete mix design to more closely match the appearance of the cementitious masonry blocks with the appearance of the finished natural stone.

11. The method of claim 9, further comprising applying a finish to the cementitious masonry blocks with natural stone finishing techniques.

12. The method of claim 9, wherein the cementitious masonry blocks each include one or more display faces having a thickness at least twice as great as a thickness of remaining sides of the cementitious masonry blocks.

13. The method of claim 12, wherein the one or more display faces include a thickness of about 3.5 inches.

14. The method of claim 9, wherein the concrete mix design includes no particles greater than about ⅛ inch in diameter.

15. The method of claim 9, wherein the aggregate includes no particles greater than about 1/64 inch in diameter.

16. A method of forming a cementitious masonry block that exhibits the appearance of natural stone, comprising:
obtaining a concrete mix design that, when cured, is matched in color or grain, or both, to the natural stone being replicated;
forming the concrete mix design into an uncured block, the uncured block having:
a length at least about 24 inches;
at least one hollow cell formed in the block to provide a void for structural reinforcing; and
one or more display faces operable to have a finish applied thereto by natural stone finishing techniques; and
curing the uncured block to create the cementitious masonry block.

17. The method of claim 16, wherein the length of the block is at least about 32 inches.

18. The method of claim 16, wherein the length of the block is at least about 40 inches.

19. The method of claim 16, wherein the block includes two display faces, and wherein one of the display faces includes a length of at least about 16 inches.

20. The method of claim 16, wherein the block includes two display faces oriented orthogonally to one another, and wherein each of the display faces includes a length greater than a depth associated with either display face.
